(19) United States
(12) Patent Application Publication
(10) Pub. No.: US 2010/0329830 A1
(43) Pub. Date: Dec. 30, 2010

(54) Conveyor vacated shopping bin

(76) Inventor: Don McLees, Everett, WA (US)

Correspondence Address: Don McLees, 2623 Virginia Ave., Everett, WA, 98201, US

(21) Appl. No.: 12/459,154

(22) Filed: Jun. 26, 2009

(51) Int. Cl. B65G 65/34; B65G 65/42

(52) U.S. Cl. 414/416.04

(57) ABSTRACT

A shopping bin which attaches to the top of a cart. The bin is detachable from the cart and can be slid onto the conveyor belt of a conventional check stand. The bin mechanism allows the conveyor belt to vacate the contents of the bin.

### FIELD OF THE INVENTION AND OBJECT OF THE INVENTION

The field of the invention is shopping and the object of the invention is to provide a large capacity shopping bin that can be easily attached to the top of any standard shopping cart and then after shopping can be easily detached and slid onto the conveyor belt of a check stand and thereby eliminate the need for the customer to unload individual items from the cart to the conveyor. Another object of the invention is to provide such a bin that has mechanism allowing the contents to be vacated by the movement of the conveyor belt and thereby eliminate the need for the checker to have to reach any further than if the items were on the conveyor. Yet another object is to provide such a bin that can be stacked one inside the other in nesting fashion and therefore require minimal storage space. A further object is to have the bin mechanism interrupt the check stand electronic photo beam and stop the conveyor as each item is vacated and thereby allow the conveyor to function in its normal manner as if the bin were not present. A still further object of the invention is to provide such a bin that requires no modification of the shopping cart and minimal modification of the check stand.

### SUMMARY OF THE INVENTION INCLUDING BACKGROUND AND PRIOR ART

As technology has evolved the general trend in shopping market layout has been toward conveyor belt check stands with most stores requiring the customers to unload items from their shopping carts onto the belt which then moves the items to the checker who manually passes the items by a scanner for identification and pricing. One of the problems with such a system is that most customers would prefer not to be burdened by the task of unloading each item from their cart. Another related problem from the customer's perspective is that while they are occupied by the task of unloading the cart their attention is diverted from the register display showing prices as the checker scans items. A problem with the system from the store's perspective is often evident when an elderly or otherwise physically handicapped customer cannot keep up with the conveyor/checker and thus impedes throughput. Some shoppers place a hand carried basket of items on the conveyor which simply transfers the burden of item removal to the checker and the baskets have small capacity compared to a cart.

The desire to eliminate the current inefficiencies led to this invention, the conveyor vacated shopping bin. Envisioned is a nested stack of bins available to the customers as they access their shopping carts. The bin is placed crosswise on top of the cart at the front leaving room to the rear for placement of bulk items into the cart. The customer then places all the desired smaller items into the bin. Since an opaque bin may make it more difficult for the customer to identify their particular shopping cart by viewing items inside from a distance should they wander away to seek individual items, envisioned is either a transparent bin or a system of multi-colored bins.

At the check stand the configuration of the bottom of the bin allows the customer to simply twist and pull the bin to separate it from the cart, allowing the bin to be slid onto the check stand conveyor belt with the aid of a small roller at the front of the bin. Thus the customer does not have to lift the weight of the bin and its contents.

The conveyor then moves the bin to the check stand photo beam where a beam interrupter attached under the bin front door breaks the photo beam and causes the conveyor to stop. When the checker opens the front door of the bin the beam interrupter is moved out of the path of the photo beam which causes the conveyor to start and move the bin a short distance to a bin stop alongside the belt. But while the bin has been stopped the conveyor keeps moving. Inside the bin at the back are a back plate and a bottom plate which form an evacuator that is not directly attached to the bin but rather is attached through slots to runners under the bin. Thus the moving conveyor causes the evacuator to push the items toward the door opening at the checker. While the evacuator is a very simple means of vacating bin contents it should be noted that other mechanisms could be used, such as a conveyor belt inside the bin powered by a roller in contact with the check stand conveyor.

An item sensor at the front of the bin activates another beam interrupter which causes the conveyor to stop each time a new item arrives. Thus the check stand still functions in the same manner as if the bin were not there. The evacuator also activates the beam interrupter when it reaches the front of the bin causing the conveyor to stop. It should be herein mentioned that the item detector need not be mechanical but could be simply the check stand beam diverted by mirrors to inside the bin. When vacated the checker picks up the bin and tilts it, causing the evacuator to slide back and the door to close. The bin can then be nested into another stack. Also envisioned is a conveyor vacated bin that incorporates means for product identification such as a bar code scanner or a radio frequency tag reader. It should also be noted that the cart need not be a standard shopping cart but could be a specialized cart if so desired.

Several inventions have taught how to make check stand operation more efficient. These include U.S. Pat. Nos. 3,036,722, 3,306,398, 3,924,709 and 4,373,611, all of which incorporate a conveyor in a cart. U.S. Pat. No. 4,043,426 shows a cart with a basket that is slidable to the checker. All such approaches require a specialized and quite expensive cart and extensive modifications to the check stand. The customer is required to position the cart correctly for unloading. Either all bulk items must go through the same unloading and scanning procedure, cumbersome at best, or a separate special procedure would be needed. Only one customer can be served at a time whereas the conveyor vacated bin system allows one bin or indeed even individual items to be placed on the conveyor as the former bin is being evacuated. The slidable basket version is further restricted by a trade off between capacity and distance the checker must reach for items.

### BRIEF DESCRIPTION OF THE DRAWINGS

FIG. 1 shows the bin cross-mounted on the cart at the check stand prior to removal and a second bin in its unload position on the conveyor.

FIG. 2 is a detailed drawing of inside the bin as viewed from the door end.

FIG. 3 is a detailed drawing of the bottom of the bin also as viewed from the door end.

### DETAILED DESCRIPTION OF THE DRAWINGS OF THE PREFERRED EMBODIMENT

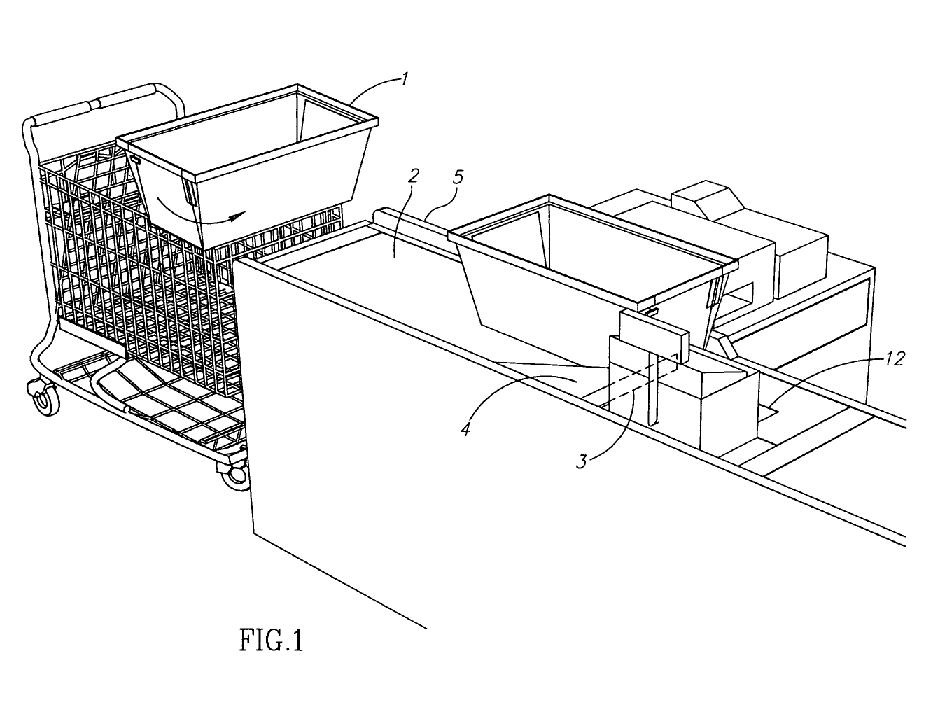

The arrow of FIG. 1 shows the direction the bin (1) is twisted to release it from the cart prior to the bin being slid onto the check stand conveyor (2) by the customer. A second bin has been moved by the conveyor to the bin stop (3) and is shown in its unload position. The bin has been guided to its unload position by the outer rail bin guide (4) and the check stand inner guide rail (5).

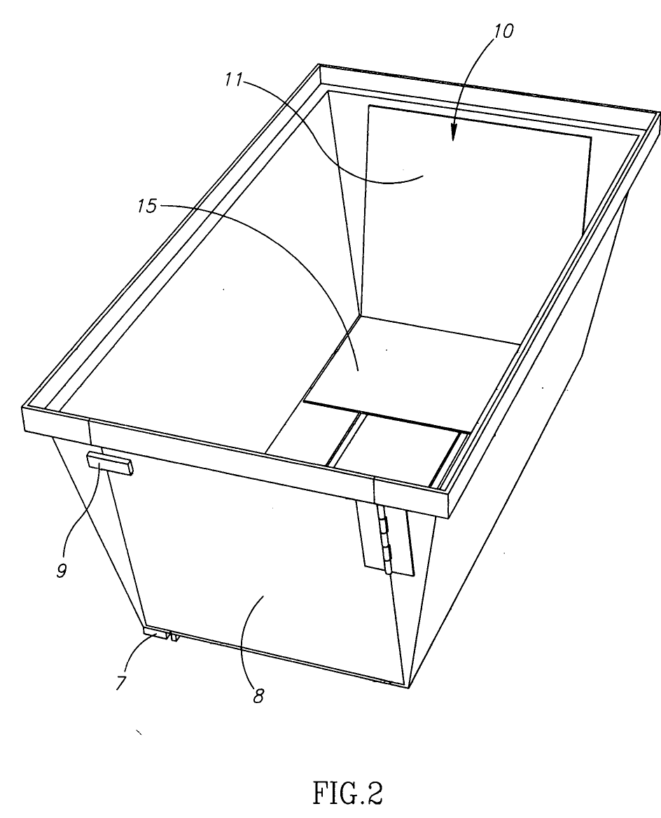

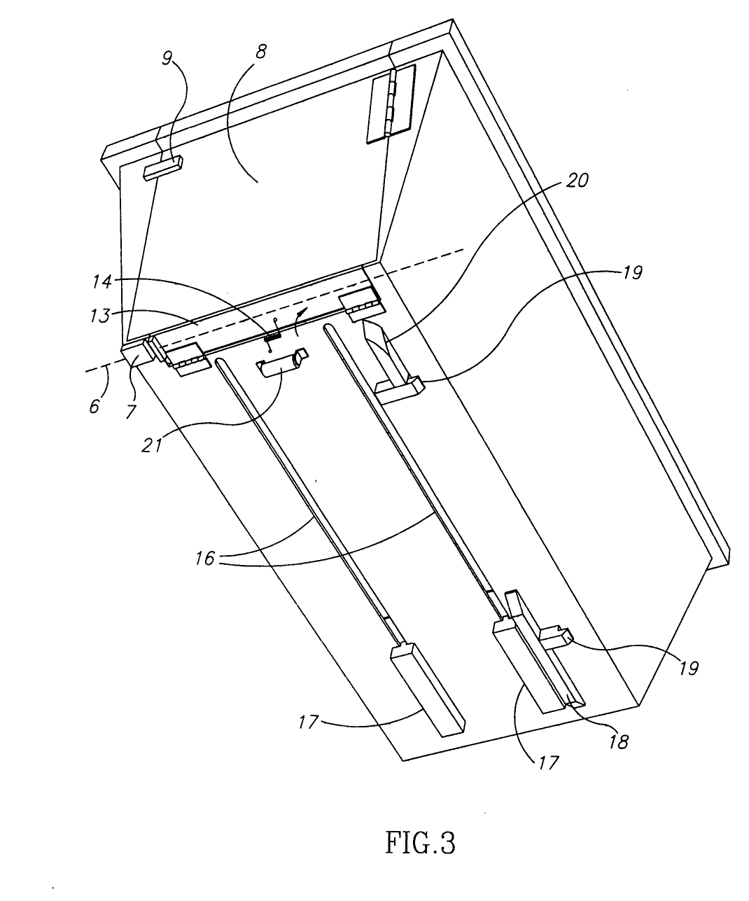

The basic workings of the bin can be seen in FIG. 2. The bin evacuation process begins when the checker unlatches the bin door catch (9) and opens the bin door (8) with its attached beam interrupter (7). This action opens the photo beam which in turn initiates conveyor movement. The back plate (11 of FIG. 2) with the bottom plate (15) form the evacuator (10) which is attached by fasteners going through the bin slots (16 of FIG. 3) to runners (17 of FIG. 3) under the bin. The fasteners have spacers such that the bottom plate of the evacuator is in contact only with the runners. With the weight of the items on the bottom plate transferred to the runners in contact with the conveyor and not on the bottom of the bin, and since the bin cannot move because it is being held by the bin stop (3 of FIG. 1), the laws of physics dictate that the moving conveyor must move the evacuator and the rest of the items in the bin forward.

FIG. 3 shows the configuration underneath one version of the preferred embodiment. The versions may change slightly depending on the specifics of the particular cart to which the bins will be attached. The guides (18 and 20) center the bin on the cart and position it for the lock tabs (19) to engage the top rail of the cart as the bin is slid forward. Since cart designs are varied, and indeed some don't even have a top rail, the exact means of bin engagement with the shopping cart may vary. The left lock in the drawing (which would be the right hand lock with the bin positioned on the cart) has a tapered wedge releasing protrusion (20). As the bin is twisted the protrusion lifts the lock over the cart top rail and the front roller (21) aids in sliding the bin onto the conveyor. While it is not the purpose here to describe every possible bin configuration, clearly the addition of rollers, wheels or other friction reducing devices could lessen the force required to move the bin from the cart to the conveyor depending on the specifics of the particular shopping cart. The right runner in the drawing (left runner as the bin is positioned on the conveyor) in the preferred embodiment may be made of a material with a higher coefficient of friction than the left runner thus establishing a torque force as the conveyor slides in contact with the runners and thereby pushes the bin against the left check stand guide rail (5 of FIG. 1). Once the bin is in its final unload position the front roller (21) eliminates any forward force on the bin from the conveyor as the conveyor moves the evacuator and the bin contents toward the scanner (12 of FIG. 1). The item detector strip (13) and its torsional return spring (14) is shown at the front of the bin.

What is claimed is:

1. A shopping bin in combination with a standard check stand conveyor belt, said bin having check stand conveyor communication means and check stand conveyor powered evacuation means.

2. The shopping bin of claim 1 in combination with a wheeled conveyance and a standard check stand conveyor belt, said bin having said wheeled conveyance attaching and detaching means and check stand conveyor powered evacuation means.

3. The shopping bin of claim 2, said wheeled conveyance detaching means including a plurality of friction reducing devices.

4. The shopping bin of claim 2, the check stand conveyor powered evacuation means being provided by a conveyor belt interior to the bin and in communication with said standard check stand conveyor belt.

5. A conveyor belt vacated shopping bin in combination with a standard check stand conveyor belt, said bin being openable at the front and having an evacuator, said evacuator being located substantially toward the rear of said bin and comprising a bottom portion and a rear portion, said evacuator having check stand conveyor belt communication means and said evacuator being moveable to a position substantially toward the front of the bin.

6. The shopping bin of claim 5, said evacuator of said bin extending substantially across the width of the bin and said check stand conveyor belt communication means being provided by evacuator attaching means passing through an opening in the bottom of the bin and attached to support structure underneath the bin.

7. The shopping bin of claim 6, the said check stand conveyor belt communication means of said bin having a plurality of openings in the bottom of the bin.

8. The shopping bin of claim 7, the said plurality of openings comprising two substantially parallel slots extending substantially the length of the bin.

9. The shopping bin of claim 6, said support structure comprising two substantially parallel runners.

10. The shopping bin of claim 9, one of the said runners of said bin being made of a material having a substantially higher coefficient of friction than the other runner.

11. A conveyor vacated shopping bin in combination with a wheeled bin conveyance means, a standard check stand conveyor belt and a standard check stand photo beam, said bin being attachable to and detachable from said wheeled bin conveyance means, the bin having an openable front portion with a photo beam interrupting tab attached thereto and the bin also having a photo beam interrupting item detector.

12. The shopping bin of claim 11, said wheeled bin conveyance means being a standard shopping cart.

13. The shopping bin of claim 11 made of a transparent material.

14. The shopping bin of claim 11 having color coded identification means.

15. The shopping bin of claim 11, said item detector comprising a plurality of photo beam diverting mirrors.

16. The shopping bin of claim 11, said photo beam interrupting item detector comprising a sensing member occluding the path of items in its stand-by position, a photo beam occluding member in its item sensing position and a return spring which returns the photo beam occluding member from its sensing position to its stand-by position.
